(19) United States
(12) Patent Application Publication
(10) Pub. No.: US 2007/0298732 A1
(43) Pub. Date: Dec. 27, 2007

(54) Polar transmitter using binary phase shift key (BPSK) modulation method

(75) Inventors: Jeong-hoon Lee, Yongin-si (KR); Seung-woo Kim, Yongin-si (KR); Jae-sup Lee, Yongin-si (KR); Eun-chul Park, Yongin-si (KR); Young-sik Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/634,093

(22) Filed: Dec. 6, 2006

(30) Foreign Application Priority Data
Jun. 19, 2006 (KR) 10-2006-0054735

(51) Int. Cl. H04B 1/02; H04B 1/66

(52) U.S. Cl. 455/102

(57) ABSTRACT

A polar transmitter using a binary phase shift key (BPSK) method includes a data dividing unit which divides input data into an amplitude component and a phase component, a frequency synthesizer which produces an I value of a passband having a phase component of an I signal and a Q value of a passband having a phase component of a Q signal, a polar modulation circuit for the I signal which produces an I carrier wave to the I signal using the amplitude component from the data dividing unit and the I value from the frequency synthesizer, a polar modulation circuit for the Q signal which produces a Q carrier wave to the Q signal using the amplitude component and the Q value, and a carrier wave producing unit which combines the I carrier wave and the Q carrier wave thus to produce a carrier wave.

### CROSS-REFERENCE TO RELATED APPLICATIONS

This application claims priority under 35 U.S.C. §119(a) of Korean Patent Application No. 10-2006-054735, filed Jun. 19, 2006, in the Korean Intellectual Property Office, the entire disclosure of which is incorporated herein by reference.

### FIELD OF THE INVENTION

Apparatuses and methods consistent with the present invention relate generally to a polar transmitter using a binary phase shift key (BPSK) modulation method in which a distributed active transformer (DAT) is mounted. More particularly, the present invention relates to a polar transmitter using a BPSK modulation method in which a DAT is mounted, and which can process data at a high speed, thereby allowing the polar transmitter to apply to multimode and multiband applications and uses a BPSK modulation method to simplify circuit construction.

### BACKGROUND OF THE INVENTION

Generally, a spread spectrum type transmitter mainly uses a sine wave, a pulse wave, etc. as a carrier wave. To transmit data, however, the sine wave and the pulse wave should be increased in a predetermined frequency. For this, the transmitter requires elements to up-convert the carrier wave from a baseband to the predetermined frequency.

As methods of up-converting the carrier wave to the predetermined frequency in the transmitter, there are a super heterodyne method to up-convert the carrier wave from the baseband to the predetermined frequency via an intermediate frequency (IF) band, and a direct conversion method to directly up-convert the carrier wave from the baseband to the predetermined frequency.

A transmitter employing the super heterodyne method requires a voltage controlled oscillator (VCO) to produce a frequency of the IF band, a VCO for radio frequency (RF) to produce a frequency of an RF band, a phase locked loop (PLL) for IF and a PLL for RF to fix the frequencies produced from the VCO for IF and the VCO for RF, respectively, not to change under an external influence, an up-mixer for IF to up-convert a carrier wave of the baseband to the frequency of the IF band produced from the VCO for IF, and an up-mixer for IF to up-convert the carrier wave of the IF band to a frequency of the predetermined frequency band. In addition, the transmitter requires a surface acoustic wave (SAW) filter to remove an image signal, and a power amplifier (PA) having a superior linearity. Such a super heterodyne type transmitter is disadvantageous in that circuit parts are large in number, so that circuit construction is complicated and adjustments are difficult.

A transmitter employing the direct conversion method requires a VCO, a PLL, an up-mixer, a PA, etc., and thus has circuit parts reduced in number as compared with the super heterodyne type transmitter. However, the direct conversion type transmitter still requires the PA to have a superior linearity. In addition, to meet a noise level required for a Global System for Mobile communication (GSM) standard, the direct conversion type transmitter needs to install a separate filtering means on a rear end of the PA. Also, the direct conversion type transmitter presents a problem in that a signal is lowered in quality due to a noise by a DC component and a mismatching between an I signal and a Q signal.

To address the problems of the super heterodyne type transmitter and the direct conversion type transmitter, there has been proposed a polar transmitter.

The polar transmitter divides data, which is provided in the form of an I signal and a Q signal, into an amplitude component and a phase component and processes them. As illustrated in FIG. 1, the polar transmitter includes a modulator 10, a PLL 20, a VCO 30, a power amplifier 40, an amplitude control loop 50, a phase control loop 60.

The modulator 10 receives the I signal and the Q signal and divides them into amplitude components and phase components, respectively. The PLL 20 generates a control signal, so that a carrier wave of a predetermined frequency, which has a phase corresponding to the input phase components, is output from the VCO 30.

The power amplifier 40 receives the carrier wave output from the VCO 30 and an amplitude control signal output from the amplitude control loop 50, and outputs a carrier wave having a predetermined amplitude and a predetermined phase.

The amplitude control loop 50 processes the amplitudes divided by the modulator 10 so as to produce the amplitude control signal for providing to the power amplifier 40, and at the same time, estimates an amplitude of the carrier wave output from the power amplifier 40 and provides the amplitude control signal to the power amplifier 40 according to the estimated amplitude.

The phase control loop 60 estimates a phase of the carrier wave output from the power amplifier 40 and provides a signal for controlling the phase to the PLL 20 according to the estimated phase.

Such a related art transmitter uses the PLL 20 in order to produce the carrier wave. The PLL 20 is provided with a feedback circuit to give a feedback to the VCO 30 to produce a carrier wave having an accurate frequency and an accurate phase. The feedback circuit of the PLL 20 operates whenever the frequency and the phase of the carrier wave are modulated, and thus a time which compares the phase through the feedback circuit every phase modulation is used. Accordingly, in case of using the PLL 20, a modulation speed is subject to restriction due to the operation of the feedback circuit.

Also, in the related art polar transmitter, it is important to synchronize the phase and the amplitude in the phase modulation and the amplitude modulation. Accordingly, the related art polar transmitter further includes feedback circuits for synchronization provided in the amplitude control loop 50 and the phase control loop 60. As a result, an entire modulation time for outputting the carrier wave is increased, and circuit construction is complicated.

On the other hand, in recent times, as communication standards related to radio communication have developed and diversified, a transmitting and receiving device for radio communication, which can operate in different modes and use one or more standard or frequency band, is desired. For instance, a transmitting and receiving device for radio communication, which supports a code division multiple access (CDMA) 1× and/or a general packet radio service (GPRS), a global system for mobile communication (GSM) and a wideband code division multiple access (WCDMA), is desired.

To support the multimode capability, one or more reference oscillator is required in a single transmitting and receiving device. Accordingly, the related art device is designed, so that it has two separate PLLs 20 and a switch installed therebetween. However, this design results in an increase in size and cost, and a reduction in design efficiency.

Thus, one or more VCO 30, and a PLL 20 are desired in the multimode transmitting and receiving device so as to be operable in various frequencies and capable of supporting various standards. However, since the feedback circuit of the PLL 20 results in the time delay, it is not adapted to use the PLL 20 in a multi-band system.

Accordingly, there is desired a polar transmitter capable of operating at a high speed to quickly modulate a new frequency even though it is changed to a different mode, thereby being adapted to a multimode and a multi-band. Also, a method is desired which is capable of reducing the entire modulation time for outputting the carrier wave and simplifying construction of the circuit.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention is to provide a polar transmitter using a binary phase shift key (BPSK) modulation method, which is capable of processing data at a high speed, thereby allowing the polar transmitter to be applicable to multimode and a multiband applications, and simplifying circuit construction.

According to an aspect of The present invention, there is provided a polar transmitter including a data dividing unit to handle input data with a predetermined process thus to divide the input data into an amplitude component and a phase component, a frequency synthesizer to produce an I value of a passband having a phase component of an I signal and a Q value of a passband having a phase component of a Q signal, a polar modulation circuit for the I signal to produce an I carrier wave to the I signal using the amplitude component from the data dividing unit and the I value from the frequency synthesizer, a polar modulation circuit for the Q signal to produce a Q carrier wave to the Q signal using the amplitude component from the data dividing unit and the Q value from the frequency synthesizer, and a carrier wave producing unit to combine the I carrier wave and the Q carrier wave thus to produce a carrier wave.

The polar modulation circuit for the I signal may include a first switching power amplifier to adjust and output the i value produced from the frequency synthesizer according to the amplitude component, and a first amplitude modulator to provide an amplitude control signal corresponding to the amplitude component, so that an I carrier wave with a predetermined amplitude is output from the first switching power amplifier.

The polar modulation circuit for the I signal may include a first pulse shaping filter to restrict a band of an amplitude component of the I signal.

The polar modulation circuit for the I signal may further include a first delaying unit to delay the phase component by a predetermined time.

The first delaying unit may delay the phase component by a time required for processing the amplitude component at the first pulse shaping filter.

The I value produced from the frequency synthesizer may have a phase component of 0° or 180°.

The polar modulation circuit for the I signal may further include a first multiplexer to selectively output one out of I values produced from the frequency synthesizer when the time delayed by the first delaying unit elapses.

The first switching power amplifier may adjust an amplitude of the I value output from the first multiplexer according to an amplitude control signal from the first amplitude modulator to output the I carrier wave.

The polar modulation circuit for the Q signal may include a second switching power amplifier to adjust and output the Q value produced from the frequency synthesizer according to the amplitude component, and a second amplitude modulator to provide an amplitude control signal corresponding to the amplitude component, so that a Q carrier wave with the amplitude component is output from the second switching power amplifier.

The polar modulation circuit for the Q signal may include a second pulse shaping filter to restrict a band of the amplitude component.

The polar modulation circuit for the Q signal may further include a second delaying unit to delay the phase component by a predetermined time.

The second delaying unit may delay the phase component by a time required for processing the amplitude component at the second pulse shaping filter.

The Q value produced from the frequency synthesizer may have a phase component of 90° or 270°.

The polar modulation circuit for the Q signal may further include a second multiplexer to selectively output one out of Q values produced from the frequency synthesizer when the time delayed by the second delaying unit elapses.

The second switching power amplifier may adjust an amplitude of the Q value output from the second multiplexer according to an amplitude control signal from the second amplitude modulator to output the Q carrier wave.

The frequency synthesizer may be a phase locked loop (PLL).

The carrier wave producing unit may be a transformer to combine an I carrier wave output from a first switching power amplifier of the polar modulation circuit for the I signal and a Q carrier wave output from a second switching power amplifier of the polar modulation circuit for the Q signal.

The transformer may include at least one primary coil to connect an output end of the first switching power amplifier and an output end of the second switching power amplifier, and a secondary coil connected in parallel with the primary coil to produce the carrier wave.

The carrier wave producing unit may be a distributed active transformer (DAT).

The data dividing unit may be a modem.

A limiter or a buffer for obtaining a phase-modulated signal with a predetermined amplitude may be disposed between the first delaying unit and the first multiplexer or between the second delaying unit and the second multiplexer.

### BRIEF DESCRIPTION OF THE DRAWINGS

The above and other aspects of the present invention will become more apparent by describing in detail exemplary embodiment thereof with reference to the attached drawing figures, wherein;

FIG. 1 is a schematic circuit diagram exemplifying a related art polar transmitter;

FIG. 2 is a schematic circuit diagram exemplifying a polar transmitter according to an exemplary embodiment of the present invention;

FIG. 3 is a circuit diagram exemplifying an example of the polar transmitter according to the exemplary embodiment of the present invention;

FIG. 4 is a graph exemplifying a trace of a carrier wave output from the polar transmitter according to the exemplary embodiment of the present invention; and

FIG. 5 is a graph exemplifying a comparison result between a spectrum performance of the polar transmitter of the exemplary embodiment of the present invention and that of the related art polar transmitter.

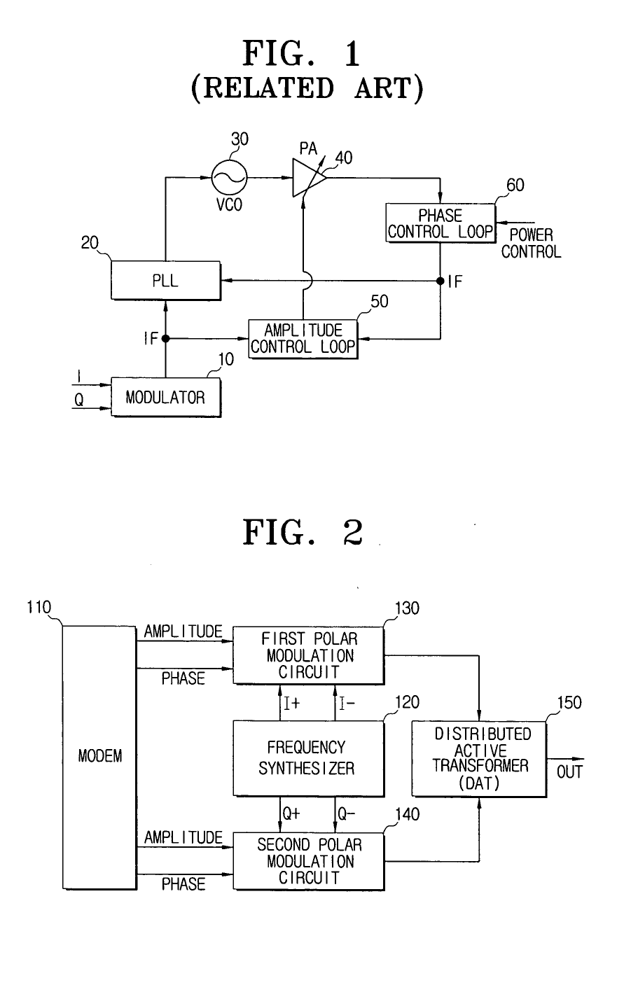

Throughout the drawings, the same drawing reference numerals will be understood to refer to the same elements, features, and structures.

### DETAILED DESCRIPTION OF THE EXEMPLARY EMBODIMENTS OF THE INVENTION

The matters defined in the description such as a detailed construction and elements are provided to assist in a comprehensive understanding of the exemplary embodiment of the invention and are merely exemplary. Accordingly, those of ordinary skill in the art will recognize that various changes and modifications of the exemplary embodiment described herein can be made without departing from the scope and spirit of the invention. Also, descriptions of well-known functions and constructions are omitted for clarity and conciseness.

FIG. 2 is a schematic circuit diagram exemplifying a polar transmitter according to an exemplary embodiment of the present invention.

The polar transmitter according to the exemplary embodiment of the present invention includes a modem 110, a frequency synthesizer 120, a polar modulation circuit for the I signal 130, a polar modulation circuit for the Q signal 140, and a distributed active transformer (DAT) 150.

The modem 110 divides data into a phase component and an amplitude component. The phase component and the amplitude component divided by the modem 110 are provided to the polar modulation circuit for the I signal 130 and the polar modulation circuit for the Q signal 140, respectively.

The frequency synthesizer 120 produces a frequency of a passband, and produces and outputs a phase component which an I signal moving along an I axis in a coordinate system can possess, and a phase component which a Q signal moving along a Q axis in the coordinate system can possess, in the passband. Here, the phase component which the I signal can possess, is 0° or 180°, and the phase component which the Q signal can possess, is 90° or 270°. Signals with the phase component of the I signal are defined as a +I value and a −I value, respectively and signals with the phase component of the Q signal are defined as a +Q value and a −Q value, respectively.

The polar modulation circuit for the I signal 130 selects one out of the +I value and the −I value output from the frequency synthesizer 120, and adjusts an amplitude of the selected +I or −I value to produce an I carrier wave.

The polar modulation circuit for the Q signal 140 selects one out of the +Q value and the −Q value output from the frequency synthesizer 120, and adjusts an amplitude of the selected +Q or −Q value to produce an Q carrier wave.

DAT 150 combines the I carrier wave and the Q carrier wave to output a carrier wave to be transmitted.

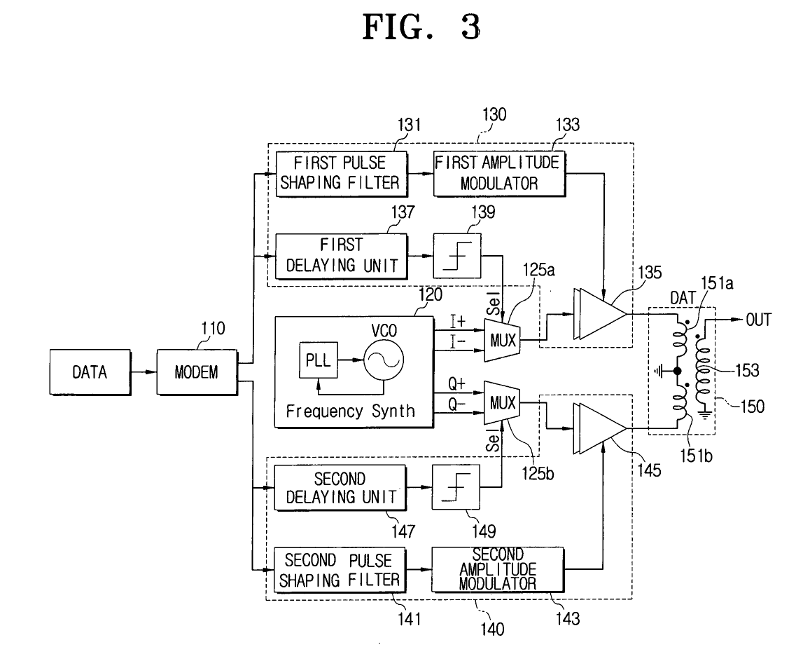

FIG. 3 is a circuit diagram exemplifying an example of the polar transmitter of FIG. 2.

According to the example of the polar transmitter, the frequency synthesizer 120 is formed of a phase locked loop (PLL) and a voltage controlled oscillator (VCO), and produces a +I value and a −I value of a passband having a phase component of an I signal, respectively, and a +Q value and a −Q value of a passband having a phase component of an Q signal, respectively.

At output ends of the frequency synthesizer 120 are disposed first and second multiplexers 125a and 125b. The first multiplexer 125a selectively outputs one of the +I value and the −I value output from the frequency synthesizer 120 according to a signal from the polar modulation circuit for the I signal 130, and the second multiplexer 125b selectively outputs one of the +Q value and the −Q value output from the frequency synthesizer 120 according to a signal from the polar modulation circuit for the Q signal 140.

The polar modulation circuit for the I signal 130 includes a first pulse shaping filter 131, a first amplitude modulator 133, a first switching power amplifier 135, a first delaying unit 137, and a first limiter 139.

The first pulse shaping filter 131 restricts a hand of the amplitude component. Accordingly, when a clock of a pulse is changed from “0” to “1” or from “1” to “0”, that is, a phase is reversed at an angle of 180°, an emission of frequency spectrum is prevented.

The first amplitude modulator 133 receives the amplitude component and produces an amplitude control signal for controlling an output level of the first switching power amplifier 135. That is, the first amplitude modulator 133 outputs the amplitude control signal, which controls the first switching power amplifier 135 to output an I carrier wave having an output level corresponding to the amplitude component therefrom.

The first delaying unit 137 delays the phase component of the I signal for a predetermined time, and then provides the delayed phase component to the first multiplexer 125a. At this time, the first delaying unit 137 delays the phase component by a time required for restricting the band of the amplitude component at the first pulse shaping filter 131, and then outputs the delayed phase component. The reason is that with compensating the amplitude component for the time delayed at the first pulse shaping filter 131, the phase component and the amplitude component are prevented from being mismatched to each other when they arrive at the first switching power amplifier 135.

The phase component delayed for the predetermined time by the first delaying unit 137 is converted into a phase-modulated signal having a predetermined amplitude at the first limiter 139 or a buffer (not illustrated), and then provided to the first multiplexer 125a.

The first switching power amplifier 135 receives the I value output from the first multiplexer 125a and the amplitude control signal provided from the first amplitude modulator 133, and adjusts an amplitude of the I value according to the amplitude control signal to output an I carrier wave. The I carrier wave output as described above is a vector value, which has a direction of 0° or 180° and the same magnitude as the amplitude in the I axis.

The polar modulation circuit for the Q signal 140 includes a second pulse shaping filter 141, a second amplitude modulator 143, a second switching power amplifier 145, a second delaying unit 147, and a second limiter 149. Functions of the polar modulation circuit for the Q signal 140 are similar to those of the polar modulation circuit for the I signal 130, except that subjects to be processed are changed from the phase and the amplitude components of the I signal to those of the Q signal. Accordingly, detailed description on the elements forming the polar modulation circuit for the Q signal 140 will be omitted for clarity and conciseness.

From the polar modulation circuit for the Q signal 140 described above are output a Q carrier wave, which is a vector value having a direction of 90° or 270° and the same magnitude as the amplitude on the Q axis.

The DAT 150, which is a transformer, combines the I carrier wave output from the polar modulation circuit for the I signal 130 and the Q carrier wave output from the polar modulation circuit for the Q signal 140 to produce a carrier wave.

The DAT 150 includes primary coils 151a and 151b to connect the first switching power amplifier 135 and the second switching power amplifier 145, and a secondary coil 153 connected in parallel with the primary coils 151a, and 151b to produce an induced current. The primary coils 151a and 151b are longitudinally divided into two parts to form an I side primary coil 151a and a Q side primary coil 151b. The I side primary coil 151a is connected to an output end of the first switching power amplifier 135, and the Q side primary coil 151b is connected to an output end of the second switching power amplifier 145. A ground is connected between the I side primary coil 151a and the Q side primary coil 151b. The secondary coil 153 produces the induced current by the I and the Q carrier waves produced from the I side primary coil 151a and the Q side primary coil 151b, and produces the carrier wave combining the I and the Q carrier waves.

Hereinafter, an operation of the polar transmitter constructed as described above will now be described.

First, when data is input into the modem 110, the modem 110 divides the data into a phase component and an amplitude component and provides the divided components to the polar modulation circuit for the I signal 130 and the polar modulation circuit for the Q signal 140, respectively.

The first pulse shaping filter 131 of the polar modulation circuit for the I signal 130 restricts a band of the amplitude component, and the first amplitude modulator 133 produces an amplitude control signal using the processed amplitude component. The produced amplitude control signal is input into the first switching power amplifier 135.

On the other hand, the phase component is delayed for a predetermined time at the delaying unit 137. And then, the phase component is converted into a phase-modulated signal having a predetermined amplitude at the first limiter 139 or the buffer and provided to the first multiplexer 125a.

The frequency synthesizer 120 outputs a +I value and a −I value having a phase component of an I signal, respectively and a +Q value and a −Q value having a phase component of a Q signal, respectively and provides them to the first and second multiplexers 125a and 125b, respectively. The first multiplexer 125a selects and outputs one out of the +I value and the −I value from the frequency synthesizer 120 according to the phase component delayed by and input from the first delaying unit 137.

The one of the +I value and the −I value output from the first multiplexer 125a is input into the first switch power amplifier 135, and the first switch power amplifier 135 determines an amplitude of the +I value or the −I value according to the amplitude control signal output from the first amplitude modulator 133 and outputs an I carrier wave.

In the same manner, the polar modulation circuit for the Q signal 140 carries out the same process as that of the polar modulation circuit for the I signal 130, and thus a Q carrier wave is output from the second switch power amplifier 145.

After that, the I carrier wave from the polar modulation circuit for the I signal 130 is input into the I side primary coil 151a, and the Q carrier wave from the polar modulation circuit for the Q signal 140 is input into the Q side primary coil 151b. Then, the secondary coil 153 of the DAT 150 combines the I carrier wave and the Q carrier wave to output a carrier wave.

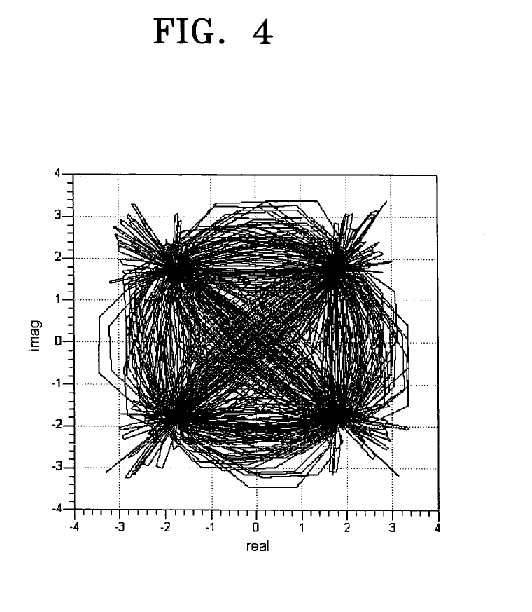

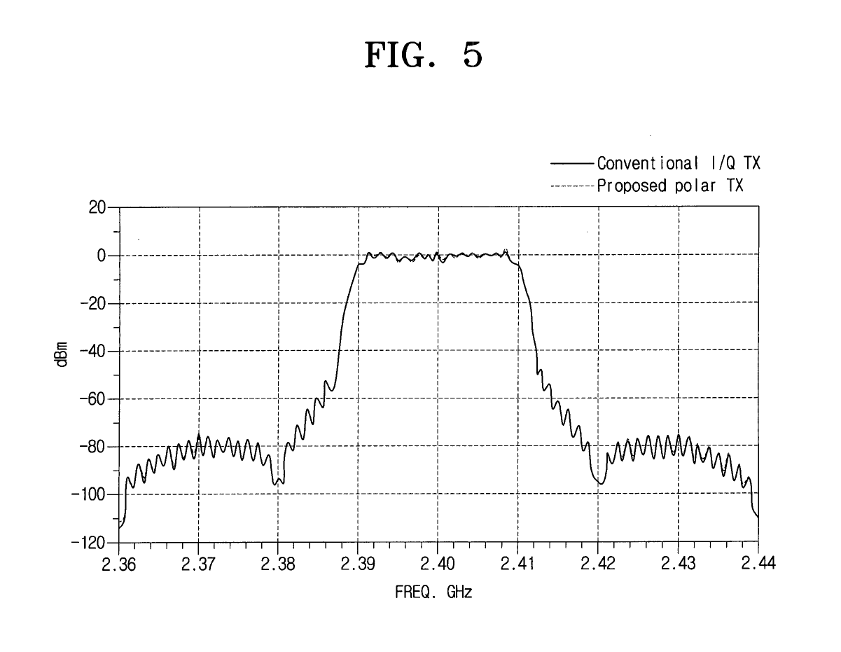

FIG. 4 is a graph exemplifying a trace of the carrier wave output from the polar transmitter according to the exemplary embodiment of the present invention, and FIG. 5 is a graph exemplifying a comparison result between a spectrum performance of the polar transmitter of the exemplary embodiment of the present invention and that of the related art polar transmitter.

As illustrated in FIG. 4, the carrier wave output from the polar transmitter according to the exemplary embodiment of the present invention was concentrated on four points on a coordinate system, and the respective points were connected through various curves. According to this, it could be appreciated that it was possible for the polar transmitter according to the exemplary embodiment of the present invention to produce a carrier wave having an accurate amplitude component and an accurate phase component in use.

Referring to FIG. 5, the polar transmitter according to the exemplary embodiment of the present invention produced a bandwidth of 20 MHz, which was the same frequency bandwidth as that of the related art transmitter. This result was very superior to a bandwidth of 200 KHz in other polar transmitters. Also, it could be appreciated that the polar transmitter according to the exemplary embodiment of the present invention has the entire spectrum, which was almost coincided with that of the related art transmitter, so that it was not only operable in a speed faster and in a bandwidth wider than those of the other polar transmitter.

As described above, the polar transmitter according to the exemplary embodiment of the present invention divides the I signal and the Q signal into the phase components and the amplitude components, respectively, and then processes them using the polar modulation circuit for the I signal 130 and the polar modulation circuit for the Q signal 140, which are operated in the BPSK method, respectively. Accordingly, the polar transmitter according to the exemplary embodiment of the present invention does not need the amplitude control loop and the phase control loop, and does not use the PLL in the phase modulation, so that it can address the speed restriction generated as a result of the use of the plurality of feedback circuit. Thus, the polar transmitter according to the exemplary embodiment of the present invention can polar-modulate at a high speed.

Also, the polar transmitter according to the exemplary embodiment of the present invention can simplify circuit construction, thereby allowing a design to be easy and allowing a power consumption and fabrication costs to be reduced.

Also, the polar transmitter according to the exemplary embodiment of the present invention is operable in a data processing speed faster and a bandwidth wider than those of the other polar transmitter. Accordingly, the polar transmitter according to the exemplary embodiment of the present invention is applicable to a multimode and a multiband.

As apparent from the foregoing description, according to the exemplary embodiment of the present invention, the polar transmitter has the fast data processing speed and the wide bandwidth, so that it applicable to the multimode and the multiband.

Also, according to the exemplary embodiment of the present invention, the polar transmitter has a simplified circuit construction, which is easy to design, and power consumption and fabrication costs are reduced.

Although a few exemplary embodiments of the present invention have been shown and described, it will be appreciated by those skilled in the art that changes may be made in this exemplary embodiment without departing from the principles and spirit of the invention, the scope of which is defined in the claims and their equivalents.

What is claimed is:

1. A polar transmitter comprising:
a data dividing unit which divides input data into an amplitude component and a phase component;
a frequency synthesizer which produces an I value of a passband comprising a phase component of an I signal and a Q value of a passband comprising a phase component of a Q signal;
a first polar modulation circuit which produces an I carrier wave for the I signal using the amplitude component from the data dividing unit and the I value from the frequency synthesizer;
a second polar modulation circuit which produces a Q carrier wave for the Q signal using the amplitude component from the data dividing unit and the Q value from the frequency synthesizer; and
a carrier wave producing unit which produces a carrier wave by combining the I carrier wave and the Q carrier wave.

2. The polar transmitter of claim 1, wherein the first polar modulation circuit signal comprises:
a first switching power amplifier which adjusts and outputs the I value produced from the frequency synthesizer according to the amplitude component; and
a first amplitude modulator which provides an amplitude control signal corresponding to the amplitude component so that an I carrier wave with a predetermined amplitude is output from the first switching power amplifier.

3. The polar transmitter of claim 1, wherein the first polar modulation circuit comprises a first pulse shaping filter which restricts a band of an amplitude component of the I signal.

4. The polar transmitter of claim 2, wherein the first polar modulation circuit further comprises a first delaying unit which delays the phase component by a predetermined time.

5. The polar transmitter of claim 4, wherein the first delaying unit delays the phase component by a time required for processing the amplitude component at the first pulse shaping filter.

6. The polar transmitter of claim 1, wherein the I value produced from the frequency synthesizer has a phase component of 0° or 180°.

7. The polar transmitter of claim 4, wherein the first polar modulation circuit further comprises a first multiplexer which outputs the I value produced from the frequency synthesizer if the time delayed by the first delaying unit elapses.

8. The polar transmitter of claim 7, wherein the first switching power amplifier adjusts an amplitude of the I value output from the first multiplexer according to an amplitude control signal from the first amplitude modulator to output the I carrier wave.

9. The polar transmitter of claim 1, wherein the second polar modulation circuit comprises:
a second switching power amplifier which adjusts and outputs the Q value produced from the frequency synthesizer according to the amplitude component; and
a second amplitude modulator which provides an amplitude control signal corresponding to the amplitude component, so that a Q carrier wave with the amplitude component is output from the second switching power amplifier.

10. The polar transmitter of claim 1, wherein the second polar modulation circuit comprises a second pulse shaping filter which restricts a band of the amplitude component.

11. The polar transmitter of claim 9, wherein the second polar modulation circuit comprises a second delaying unit which delays the phase component by a predetermined time.

12. The polar transmitter of claim 11, wherein the second delaying unit delays the phase component by a time required for processing the amplitude component at the second pulse shaping filter.

13. The polar transmitter of claim 1, wherein the Q value produced from the frequency synthesizer has a phase component of 90° or 270°.

14. The polar transmitter of claim 11, wherein the second polar modulation circuit further comprises a second multiplexer which outputs the Q value produced from the frequency synthesizer if the time delayed by the second delaying unit elapses.

15. The polar transmitter of claim 14, wherein the second switching power amplifier adjusts an amplitude of the Q value output from the second multiplexer according to an amplitude control signal from the second amplitude modulator to output the Q carrier wave.

16. The polar transmitter of claim 1, wherein the frequency synthesizer comprises a phase locked loop (PLL).

17. The polar transmitter of claim 2, wherein the carrier wave producing unit comprises a transformer which combines an I carrier wave output from a first switching power amplifier of the first polar modulation circuit and a Q carrier wave output from a second switching power amplifier of the second polar modulation circuit.

18. The polar transmitter of claim 17, wherein the transformer comprises:
at least one primary coil which connects an output end of the first switching power amplifier and an output end of the second switching power amplifier; and
a secondary coil which produces the carrier wave, wherein the secondary coil is connected in parallel with the primary coil.

19. The polar transmitter of claim 1, wherein the carrier wave producing unit comprises a distributed active transformer (DAT).

20. The polar transmitter of claim 1, wherein the data dividing unit comprises a modem.

21. The polar transmitter of claim 7, wherein a limiter or a buffer for obtaining a phase-modulated signal with a predetermined amplitude is disposed between the first delaying unit and the first multiplexer or between the second delaying unit and the second multiplexer.
